(19) United States
(12) Patent Application Publication
(10) Pub. No.: US 2020/0096352 A1
(43) Pub. Date: Mar. 26, 2020

(54) System and Method for Determining a Geographic Location for a Plurality of Users

(71) Applicant: 'smyline, LLC, New York, NY (US)

(72) Inventors: Wivelie Mesidor, Brooklyn, NY (US); Johnathan Medina, Brooklyn, NY (US)

(73) Assignee: 'smyline, LLC, New York, NY (US)

(21) Appl. No.: 16/582,895

(22) Filed: Sep. 25, 2019

Related U.S. Application Data
(60) Provisional application No. 62/736,167, filed on Sep. 25, 2018.

(51) Int. Cl. G01C 21/34; G06Q 10/02; G06Q 50/30; H04W 4/029

(52) U.S. Cl. CPC G01C 21/3438; G01C 21/343; H04W 4/029; G06Q 10/02; G06Q 50/30; G01C 21/3423

(57) ABSTRACT

A novel computerized method for determining a common physical location for a plurality of client computers is disclosed. The method comprises determining a geographic location for each of a plurality of client computers. The system determines a rate of travel for each of the client computers and arrives at a range of travel for each of the client computers. The system then determines an overlapping geographic area for selecting a meeting location for the users. The system then determines a series of available locations in the geographic area for a meeting location. The system may search public databases for information regarding potential meeting locations and then select the common physical location based on information received. The system may track users while in transit and alter a meeting location. The system can provide notifications to users regarding meeting locations.

### PRIORITY

This application claims benefit to U.S. Provisional Patent Application Ser. No. 62/736,167 filed on Sep. 25, 2018, the disclosure of which is hereby fully incorporated by reference.

### FIELD OF THE INVENTION

This invention pertains generally to computer software technology and more specifically to a system and method for determining a geographic location as a common meeting point for multiple people.

### BACKGROUND OF INVENTION

People are constantly moving from one point to another for many reasons. People often decide to meet one another for social engagements. At times individuals will meet where they reside. However, in a mobile culture such as ours, individuals often decide to meet in a third location between the two.

Deciding where to meet among multiple people can become a hassle. For instance, if the people decide to meet at a restaurant, then they have to decide which type of food they would all want to eat. Furthermore, a specific location may be deemed too far out of the way for one person. The logistics of determining a meeting place for individuals quickly becomes infinitely complex. What is needed is a system and method for drawing information from connected databases and user profile information to determine an optimal meeting point for a plurality of individuals.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a computerized method for determining a meeting location. The method is performed by a first client computer comprising one or more microprocessors and one or more nonvolatile memory units, a second client computer comprising one or more microprocessors and one or more nonvolatile memory units, and a server computer comprising one or more microprocessors and one or more nonvolatile memory units. Each of the nonvolatile memory units store instructions which, when executed by one or more microprocessors perform the novel operations.

The computerized method comprises obtaining, by said server computer, a first physical location of said first client computer owned by a first user; obtaining, by said server computer, a first selected mode of transportation of said first user; determining, by said server computer, a first rate of travel of said first selected mode of transportation; determining, by said server computer, a first travel time for said first user; calculating, by said server computer, a first range of travel for said first user from said first physical location of said first client computer; obtaining, by said server computer, a second physical location of said second client computer owned by a second user; obtaining, by said server computer, a second selected mode of transportation of said second user; determining, by said server computer, a second rate of travel of said second selected mode of transportation; determining, by said server computer, a second travel time for said second user; calculating, by said server computer, a second range of travel for said second user from said second physical location of said second client computer; determining, by said server computer, a first geographic area; wherein said first geographic area is an overlap between said first range of travel for said first user from said first physical location of said first client computer and said second range of travel for said second user from said second physical location of said second client computer; searching, by said server computer, a public database for one or more potential meeting locations, wherein said one or more potential meeting locations are within said first geographic area; and determining, by said server computer, a final specific meeting location in said first geographic area.

The step of obtaining a first selected mode of transportation of said first user further may further comprise sending, by said server computer, a request for a first mode of transportation to said first client computer; receiving, by said first client computer, said request for said first mode of transportation of said first user; receiving, by said first client computer, a first selected mode of transportation of said first user; sending, by said first client computer, to said server computer a first selected mode of transportation of said first user; and receiving, by said server computer, said first selected mode of transportation. The step of obtaining a second selected mode of transportation of said second user may further comprise sending, by said server computer, a request for a second mode of transportation to said second client computer; receiving, by said second client computer, said request for said second mode of transportation of said second user; receiving, by said second client computer, a second selected mode of transportation of said second user; and sending, by said second client computer, to said server computer said second selected mode of transportation of said second user.

The first selected mode of transportation is selected from a group consisting of: walking, bicycling, driving a car, driving a motorized bicycle, riding in a bus, riding a train, riding in an airplane and wherein said second mode of transportation is selected from a group consisting of walking, bicycling, driving a car, driving a motorized bicycle, riding in a bus, riding a train, riding in an airplane.

The computerized method may further comprise sending, by said server computer, to said first client computer, a first request for a first set of one or more preferences; receiving, by said first client computer, said first request for said first set of one or more preferences; receiving, by said first client computer, said first set of one or more preferences; wherein said first set of one or more preferences is selected from a group consisting of: a specific date and time, a preferred mode of transportation, a type of cuisine, a preferred distance of travel, a distance beyond a route of travel; transmitting, by said first client computer, said first set of one or more preferences to said server computer; sending, by said server computer, to said second client computer, a second request for a second set of one or more preferences; receiving, by said second client computer, said second request for said second set of one or more preferences; receiving, by said second client computer, said second set of one or more preferences; wherein said second set of one or more preferences is selected from a group consisting of: a specific date and time, a preferred mode of transportation, a type of cuisine, a preferred distance of travel, a distance beyond a route of travel; and transmitting, by said second client computer, said second set of one or more preferences to said server computer.

The step of calculating a first range of travel for said first user may further comprise multiplying said first rate of travel of said first selected mode of transportation by said first travel time for said first user. The step of calculating a second range of travel for said second user may further comprise multiplying said second rate of travel of said second selected mode of transportation by said second travel time for said second user.

The computerized method may further comprise transmitting, by said server computer, said final specific meeting location to said first client computer; transmitting, by said server computer, said final specific meeting location to said second client computer; transmitting, by said server computer, said final specific meeting time to said first client computer; and transmitting, by said serer computer, said final specific meeting time to said second client computer.

The computerized method may further comprise generating, by said server computer, a list of said one or more potential meeting locations; and filtering said list of said one or more potential meeting locations.

The computerized method may further comprise transmitting, by said first client computer, one or more first potential meeting times to said server computer; transmitting, by said second client computer, one or more second potential meeting times to said server computer; comparing, by said server computer, said one or more first potential meeting times to said one or more second potential meeting times; determining, by said server computer, a final specific meeting time; transmitting, by said server computer, said final meeting time to said first client computer and said second client computer.

The computerized method may further comprise searching, by said server computer, a public database for one or more specific location data points for each of said one or more potential meeting locations; wherein said one or more specific location data points are selected from a group consisting of: time of operation of a business, type of cuisine of a restaurant, public rating, business name, location name, GPS, business location, scheduled events; and determining, by said server computer, a final specific meeting location in said first geographic area based on one or more specific location data points.

The computerized method may further comprising comparing, by said server computer, said one or more specific location data points to one or more preferences of said first user; determining, by said server computer, one or more specific location data points that match one or more preferences of said first user; comparing, by said server computer, said one or more specific location data points to one or more preferences of said second user; and determining, by said server computer, one or more specific location data points that match one or more preferences of said second user.

The inventive method may also be directed toward a computerized method for determining a meeting location to be performed by a first client computer comprising one or more microprocessors and one or more nonvolatile memory units, and a server computer comprising one or more microprocessors and one or more nonvolatile memory units. Each of the nonvolatile memory units store instructions which, when executed by one or more microprocessors perform the inventive operations. The inventive method comprises receiving, by said first client computer, a request for a first meeting location; receiving, by said first client computer, a list of one or more potential attendees; transmitting, by said first client computer, said request for a first meeting location and said list of one or more potential attendees to said server computer; searching, by said server computer, a user database for one or more user profile records matching said one or more potential attendees; finding, by said server computer, one or more database records of said one or more user profile records on said user database; wherein said one or more database records comprise one or more first preferences for a first potential attendee and one or more second preferences for a second potential attendee; wherein said one or more first preferences are selected from a group consisting of: a specific date and time, a preferred mode of transportation, a type of cuisine, a preferred distance of travel, a distance beyond a route of travel, a user physical location; wherein said one or more second preferences are selected from a group consisting of: a specific date and time, a preferred mode of transportation, a type of cuisine, a preferred distance of travel, a distance beyond a route of travel, a user physical location; obtaining, by said server computer, one or more first preferences and one or more second preferences from said user database; searching, by said server computer, a location database for one or more potential meeting locations records; wherein said one more potential meeting location records further comprise one or more potential meeting location data points, wherein said one or more potential meeting location data points are selected from a group consisting of: time of operation of a business, type of cuisine of a restaurant, public rating, business name, location name, GPS, business location, scheduled events, physical location; comparing, by said server computer, one or more potential meeting location data points to one or more first preferences and one or more second preferences; determining, by said server computer, a match between said one or more potential meeting location data points and said one or more first preferences; determining, by said server computer, a match between said one or more potential meeting location data points and said one or more second preferences; selecting, by said server computer, one or more potential meeting location records wherein said one or more potential meeting location data points match said one or more first preferences and said one or more second preferences; generating, by said server computer, a list of potential meeting locations; and transmitting, by said server computer, said list of potential meeting locations to said first client computer.

In the inventive method said one or more database records further may comprise a first order of priority for said one or more first preferences and a second order of priority for said one or more second preferences. The method may further comprise obtaining by said server computer, said first order of priority and said second order of priority; respectively applying, by said server computer, one or more first priority values to said one or more first preferences; respectively applying, by said server computer, one or more second priority values to said one or more second preferences; determining, by said server computer, a first prioritized first preference and a first prioritized second preference; and selecting, by said server computer, a specific meeting location record based on said first prioritized preference and said first prioritized second preference.

The computerized method may further comprise receiving, by said first client computer, one or more location parameters; transmitting, by said first client computer, said one or more location parameters, to said server computer; comparing, by said server computer, said one or more potential meeting location data points to said one or more location parameters; determining, by said server computer, a match between said one or more potential meeting location data points and said one or more location parameters; and selecting, by said server computer, one or more potential meeting location records wherein said one or more potential meeting location data points match said one or more location parameters.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic of the system;

FIG. 2 is a schematic of a public database;

FIG. 3 is a schematic of a system database;

FIG. 4 is a schematic of the method of the invention;

FIG. 5 is a schematic of the method of the invention;

FIG. 6 is a schematic of the method of the invention;

FIG. 7 is a schematic of the method of the invention;

FIG. 8 is a schematic of the method of the invention;

FIG. 9 is an illustration of the utilization of the invention;

FIG. 10 is an illustration of the utilization of the invention;

FIG. 11 is an illustration of the method of the invention; and

FIG. 12 is an illustration of the utilization of the invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

The invention is directed toward a system and method for arranging a meeting location among multiple individuals based on information obtained from computer databases and user preferences and profile information.

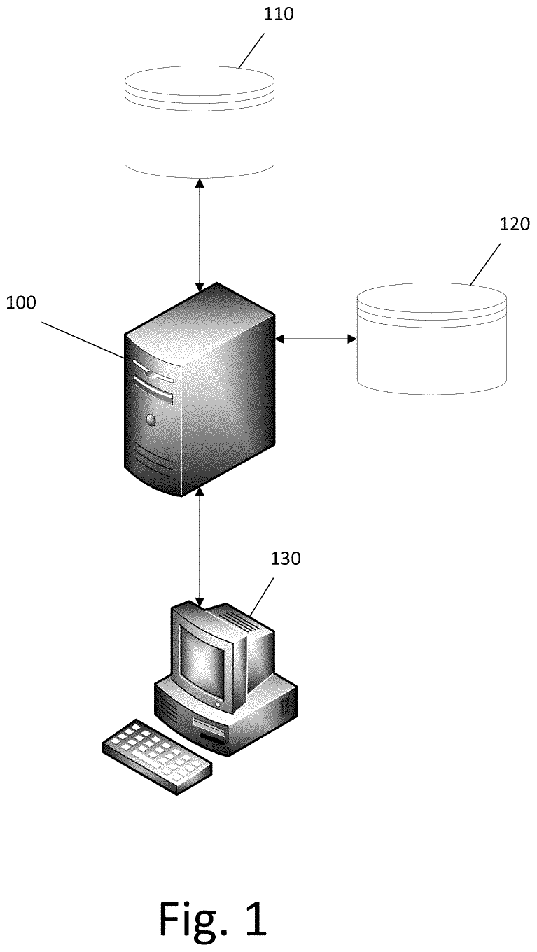

FIG. 1 illustrates a schematic of the computer system operating the method of the invention. The system comprises a client computer 130 communicatively connected to a server 100. The client computer 130 may be any type of computer device such as a desktop computer, laptop computer, smart phone, or other computer processing device. The server 100 is communicatively connected to a storage database 120 and a public database 110. The storage database 120 may be any type of database and may be integral to the server 100 or separate from the server 100. In other embodiments the storage database 120 and the public database 110 may be the same database. The storage database 120 is a database which stores information pertinent to the operation of the inventive method for fast storage and access. The public database 110 is any database which stores publicly accessible information. Information may be obtained from the public database 110 by means of scrolling, crawling, bots, spiders, or any other automated computerized method. The information obtained may then be transferred by the server 100 from the public database 110 to the storage database 120. Alternately, the server 100 may place a pointer on the storage database 120 which points any query to the location of storage on the public database 110.

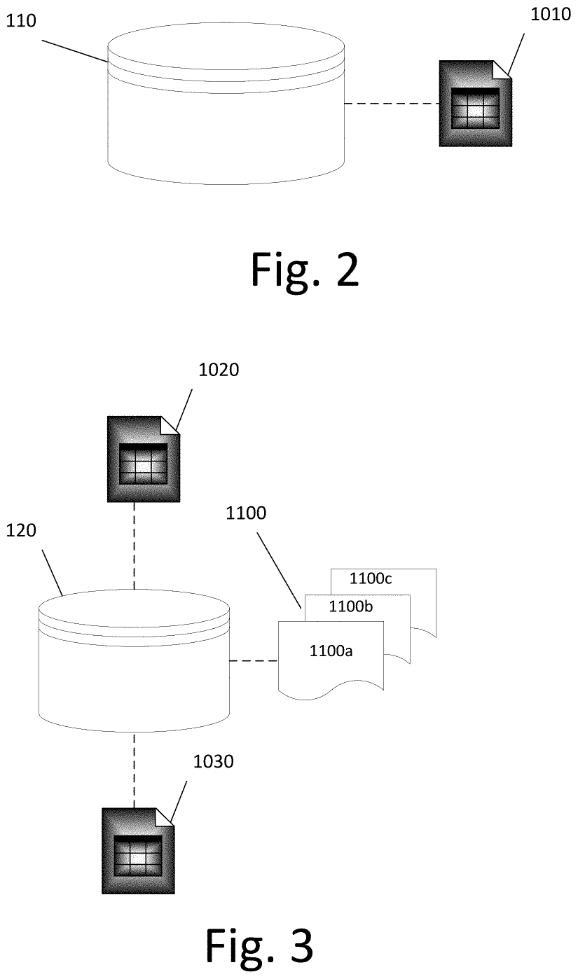

Referring to FIG. 2, a schematic of the public database 110 is illustrated. The public database 110 is any type of database and stores any type of information which is pertinent to the inventive method. As illustrated in the figure, the public database 110 stores a public record 1010. The public record 1010 is any type of computer file or data which is publicly accessible or readily available. The public record 1010 may be information related to businesses which would be desirable as a destination location, such as opening and closing times, menus, and address. The public record 1010 may be information related to users of the system, such as user profile information from social media sites. The public record 1010 may also be a calendar of public events or calendar of user availability. The public record 1010 may be in any file format or extension. A public record 1010 may be stored on a public database 110, a storage database 120, a private database, or all of the above.

Referring to FIG. 3, a schematic of the storage database 120 is illustrated. The storage database 120 is any type of database and stores any type of information or files. The storage database 120 stores a storage database file 1020. The storage database file 1020 is a database concerning the location and access to files stored on the storage database 120 or any public database 110. The storage database 120 may also store one or more records 1100. Each record 1100 may be any file type and may contain any type of information. A record 1100 may contain text, images, videos, audio, or any recorded information in any format. A record 1100 is any file stored in a computer database from which information may be extracted to utilize in determining a meeting location. A record 1100, or source file, may be stored on a public database 110, a storage database 120, a private database, or all of the above.

The storage database 120 may also have a location database file 1030. The location database file 1030 contains information concerning meeting locations and events following execution of the meeting algorithm. The location database file 1030 stores information regarding an established meeting for determining alterations to a determined meeting location or for determining preference for future meeting locations.

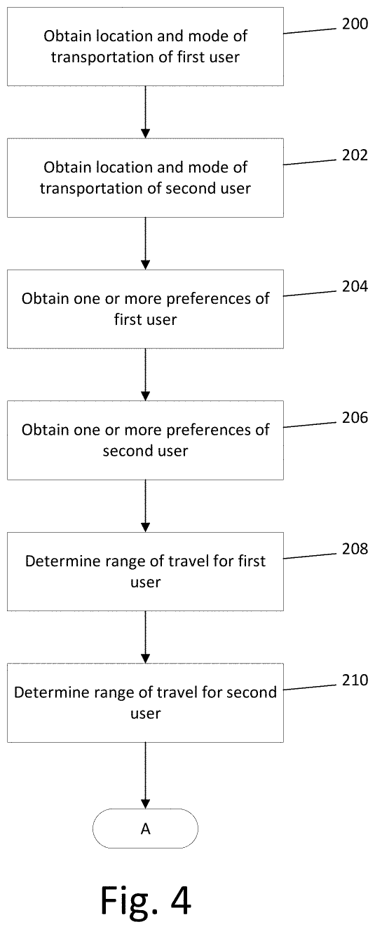

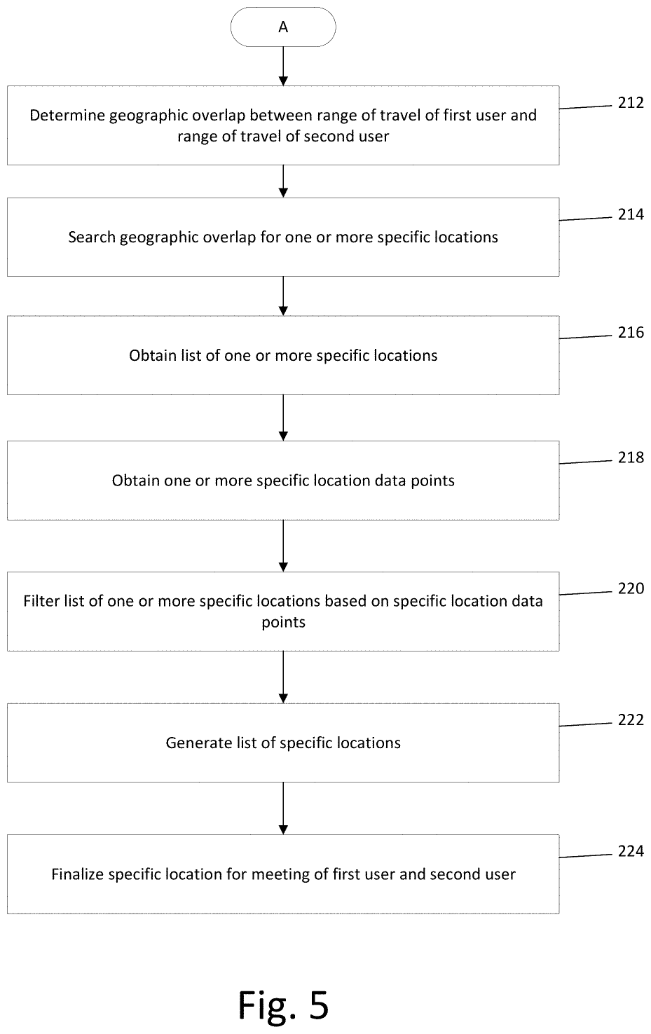

Referring to FIG. 4 and FIG. 5, the method of the invention if illustrated. First, the system obtains the location and mode of transportation of a first user 200. Then the system obtains the location and mode of transportation of a second user 202. The mode of transportation may be any means of a user to get from one location to another, such as walking, by a bicycle, by motorized bicycle, by car, by public transportation, by bus, by train, by airplane, or any means of travel. The system then obtains one or more preferences of a first user 204. The system then obtains one or more preferences of a second user 206. The preferences may be any information received from a user by the system. For instance, a preference may include a time for meeting, a mode of transportation (walking vs. driving), the type of cuisine preferred if meeting at a restaurant, the distance of travel a user is willing to travel, the distance “out of the way” or beyond a user's travel route, or any other information received by a user. The system determines a range of travel for a first user 208. The system then determines a range of travel for a second user 210. The range of travel is determined by determining the average velocity of a user (when considering the mode of transportation), the time for travel, user preferences, and public information such as amount of traffic. The system then determines a geographic overlap between the range of travel for a first user and range of travel for a second user 212. The system them searches the geographic overlap for one or more specific locations 214. The specific locations may be any type of location or place of business. The specific location may be, without limitation, a park, a restaurant, a retail store, a residence, or any other type of meeting place. The system then obtains a list of one or more specific locations 216. The list of specific locations is a list of potential meeting points for the two users. The system then obtains one or more specific location data points 218. The data points may be any information obtained from a public database 110. For instance the data points may be time of operation of a business, type of cuisine a restaurant serves, public rating (likes/dislikes or 5-star rating), business name, business location, events already scheduled, or any other information. The system then filters the list of one more specific locations based on the specific location data points received 220. For instance, if a business shows that it is closed at a certain time then the location will be removed from the list. Alternatively the system may automatically keep all closed locations from being added so that no removal is required. The system then generates a list of specific locations 222. The system then finalizes the specific location for meeting for the first user and second user 224. Lastly, the system sends notifications to the first user and second user notifying each of the meeting place where the meeting will occur.

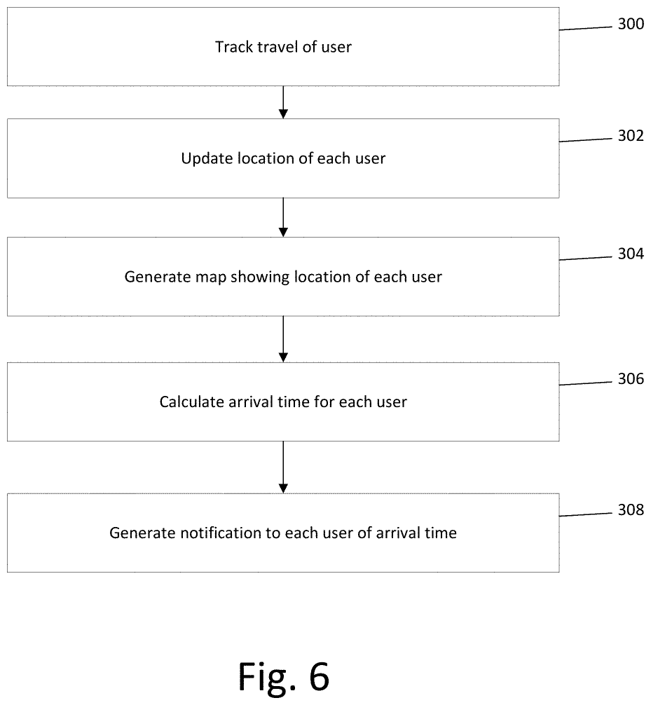

Referring to FIG. 6, the method of use during travel by the users is further illustrated. The system tracks the travel of each user 300. The users may be tracked by GPS, triangulation, user reporting a location, or any other method. The system then constantly updates the location of each user 302. The system may generate a map showing the location of each user geographically 304. The system can also calculate the arrival time for each user 306. The system may also generate a notification to each user of the anticipated arrival time for all users 308.

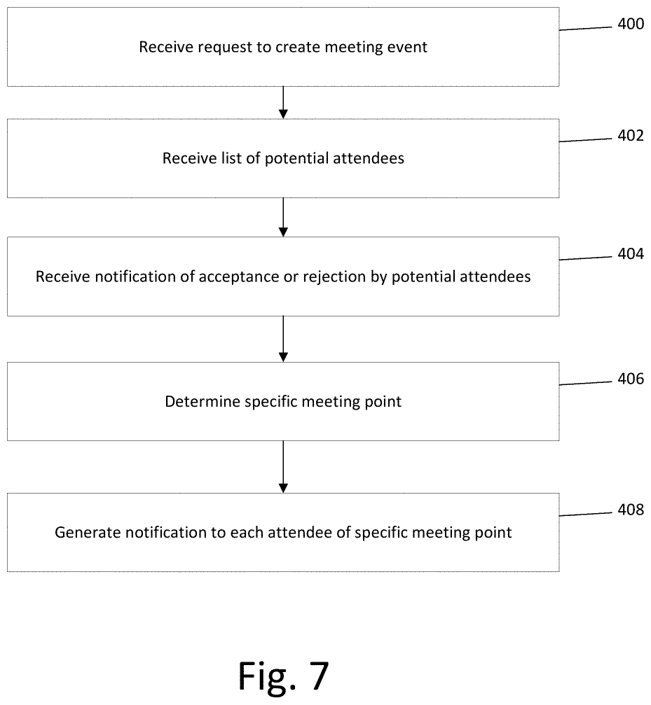

Referring to FIG. 7, the method may be utilized to create an event by a plurality of users. First, the system receives a request to create a meeting event 400. A user may sign in to the system to create a request or simply operate through a client web portal. Then the system receives a list of potential attendees 402. The system may receive the list of potential attendees from the requesting user, or pull additional user profiles from connected users, or randomly suggest attendees to the event. The system notifies the potential attendees of the event and then receives notification of acceptance or rejection by potential attendees 404. Once all attendees have been determined then the system determines a specific meeting point 406. The system may also continually update the specific meeting point as the number of users notifying that they are attending increases. The system then generates a notification to each attendee of the specific meeting point 408.

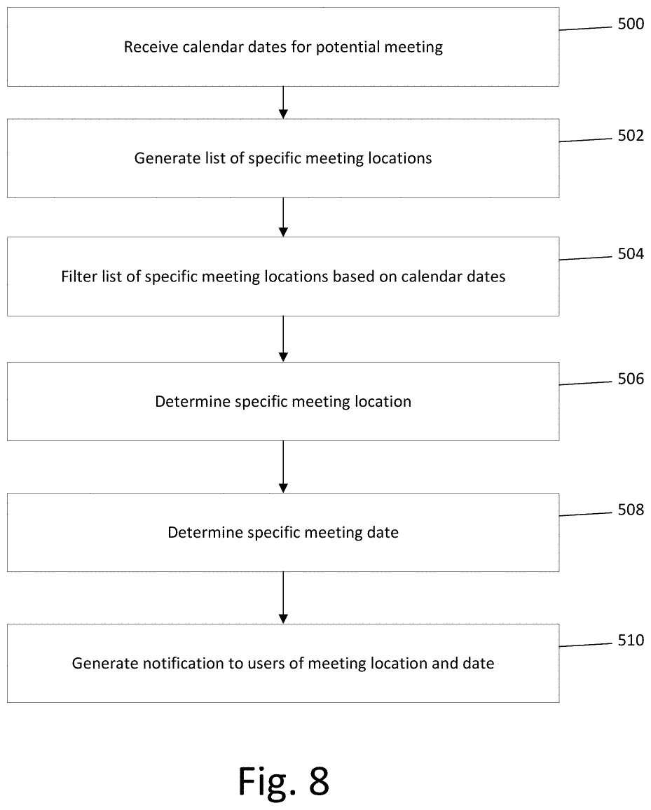

Referring to FIG. 8, the alteration of the system based on calendar information is illustrated. First the system receives calendar dates of a potential meeting 500. A user may input specific requested dates or a date range if the user is uncertain as to the time when an event may take place. The system may receive calendar dates and times from multiple users. The system then generates a list of specific meeting locations 502. The system then filters the list of specific meeting locations based on the calendar dates 504. The system determines the specific meeting location 506. The system then determines a specific meeting date 508. The system then generates a notification to users of the meeting location and date or time 510.

The system may also further utilize a calendar system. The calendar system can remind the users of upcoming meeting times and locations for meetings. The calendar system can calculate the anticipated travel time for each user who is attending the meeting. The calendar system can then send a separate notification to each user at separate times to remind the user about the meeting and notify the user that the user should leave for the meeting to ensure that the user arrives to the meeting on time. For instance, the calendar system may notify a user first that a meeting is occurring in 30 minutes and tell the user that there is approximately 25 minutes of travel time. Additionally, the calendar system may notify a second user that the same meeting is occurring in 10 minutes and tell the second user that there is approximately 5 minutes of travel time.

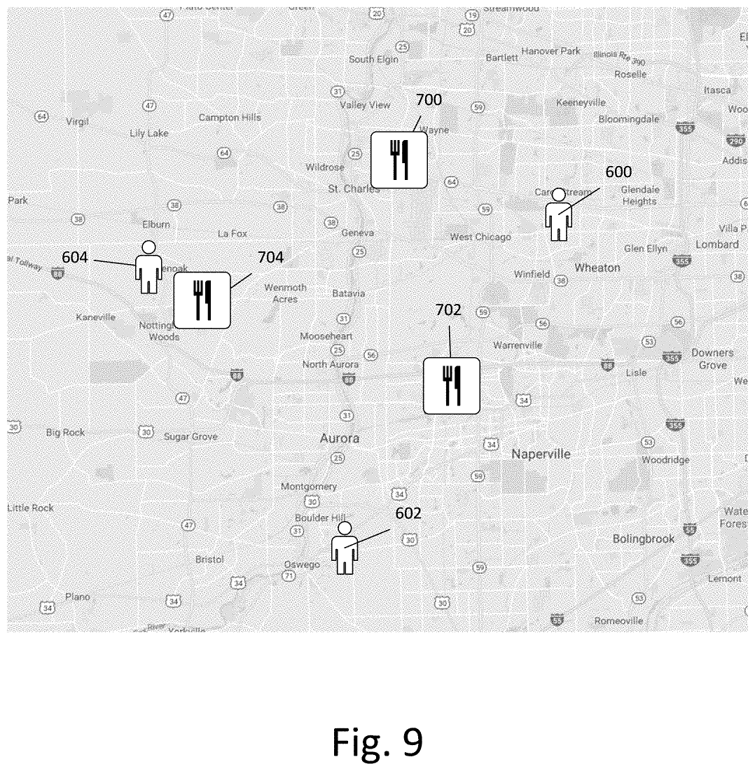

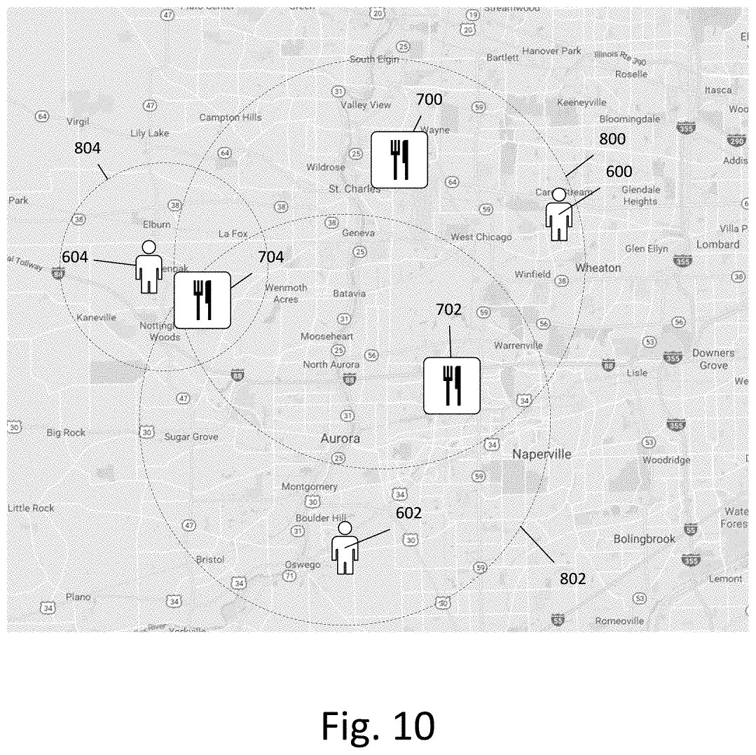

Referring to FIG. 9 and FIG. 10, the usage of the system is illustrated. As shown in FIG. 9, the system obtains the location of a first user 600, the location of a second user 602, the location of a third user 604, the location of a first restaurant 700, the location of a second restaurant 702, and the location of a third restaurant 704. As shown in FIG. 10, the system determines the range of travel of the first user 800, the range of travel of the second user 802, and the range of travel for the third user 804. As shown in FIG. 10, the range of travel for the third user 804 is the smallest due to the third user's 604 mode of transportation. The third user 804 may be walking. Alternatively, the third user 804 may be driving in heavy traffic. The system thus generates a smaller range of travel for the third user 804. The shape of the range of travel for any user may be any size and shape. The range of travel may be circular or oblong or shaped to follow travel corridors or avoid natural barriers (such as mountains). As illustrated, the system compares the range of travel for all users and determines the best location within the range of travel. In the illustration, the system determines that the third restaurant 704 is the optimal meeting place for all users and notifies all users that the third restaurant 704 is the meeting location.

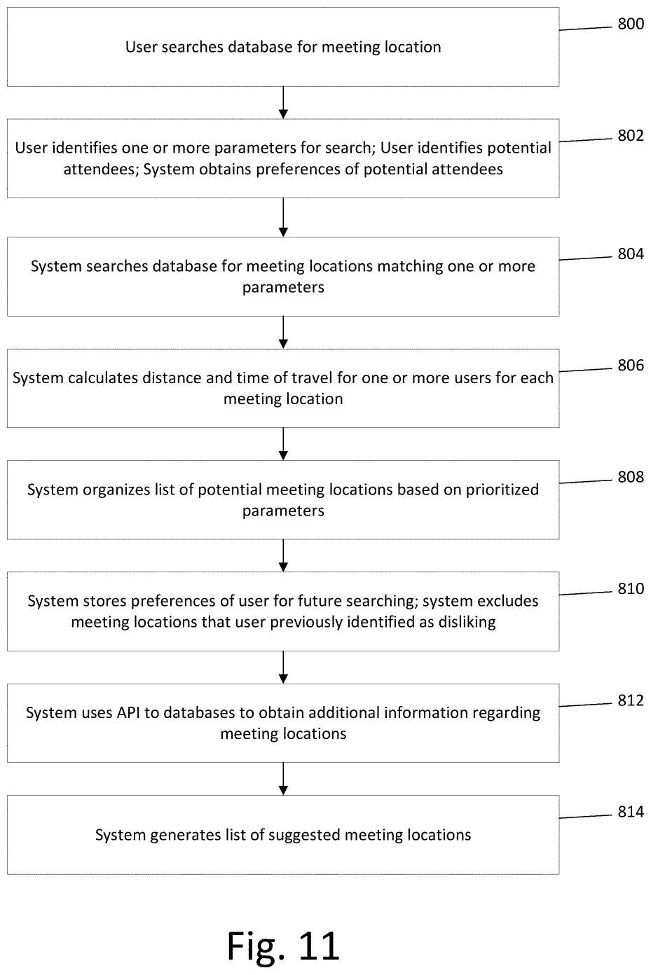

Referring to FIG. 11, the method of the system making recommendations for meeting locations is illustrated. In this method a user may start by searching the database for meeting locations 800. The user may identify one or more parameters for the search and identify potential attendees. The system then obtains the preferences of the potential attendees 802. The parameters identified by the user may be any number of parameters about the user, about the meeting location, about type of travel, about distances of other attendees, or any other number of parameters. Based on the parameters and information obtained from potential attendees the system searches the database for potential meeting locations that match one or more of the identified parameters 804. The system may then calculate the distance and time of travel for one or more users for each potential meeting location 806. If the user has prioritized parameters then the system may organize the list of potential meeting locations based on the prioritized meeting locations 810. The system then uses API links to additional software and databases to obtain additional information regarding meeting locations 812. The additional information may relate to user reviews, destination profiles, or any other information regarding the potential meeting locations. The system then generates a list of suggested meeting locations for the user 814.

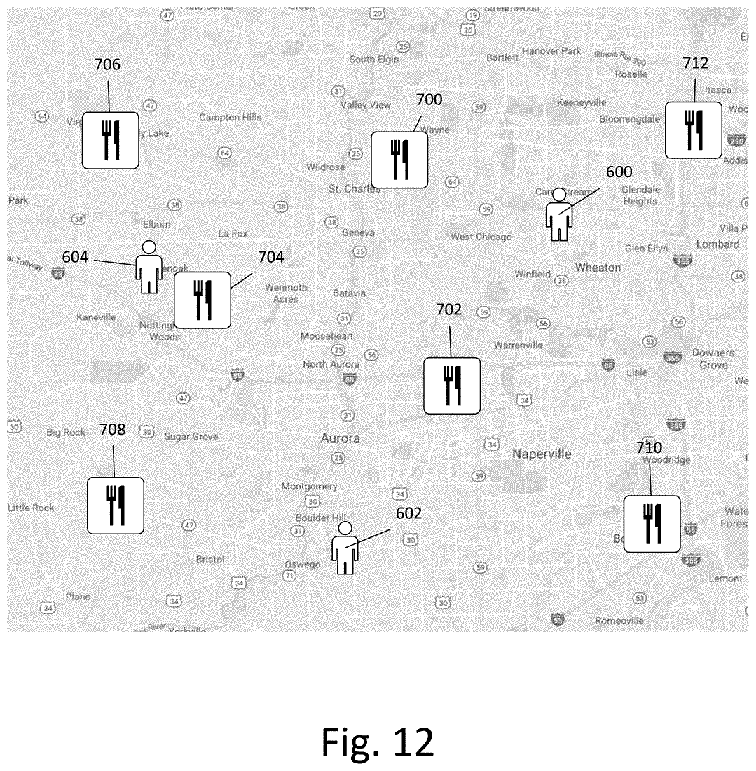

Referring to FIG. 12, the illustration of the method of suggesting locations is illustrated. As illustrated in FIG. 12, there is a first user 600, a second user 602, and a third user 604. The first user 600 enters a search for potential meeting locations and identifies the second user 602 and third user 604 as potential attendees. The system obtains the identified parameters from the first user 600 and preferences from the second user 602 and third user 604. The system searches for information from API links to other software and databases to generate a list of potential meeting locations. In the illustration, the system performs a search and suggests a first restaurant 700, a second restaurant 702, a third restaurant 704, a fourth restaurant 706, a fifth restaurant 708, a sixth restaurant 710, and a seventh restaurant 712. The first user 600 may then identify a specific meeting location, such as choosing the sixth restaurant 710 for the meeting. The first user 600 can send an invitation to the second user 602 and third user 604.

The system may be used by one user to invite any number of users. Although FIGS. 9, 10, and 12 illustrate three users, the system may be utilized with more than three users. In the preferred embodiment there is no upper limit to the number of users that the system will consider in determining a meeting location or otherwise suggesting potential meeting locations. The system makes recommendations for the best locations based on all user's travel method, ratings of locations, and other information. The system may allow a first user 600 to conduct the search based on potential locations which are closer to a second user 602. The system recommends potential meeting locations but preferably will not suggest locations which are deemed to be overly burdensome for a single user to travel to. When a user searches for a meeting location the system informs the user of the travel mode and travel time for the other potential attendees. When a meeting is set up, the system will notify all attending users of the event location and time.

In summary, the software helps users find the most convenient destinations (i.e., software recommended) based on where users are going (e.g., heading home from work), regardless of how they're traveling (e.g., driving, public transportation, bicycling), as soon as they want it (e.g., soon, later, half way), regardless of what city they're in (e.g., New York, Paris, Tokyo).

Using open API sources, the software makes recommendations for best destination options (e.g., restaurant, cafe) along the user's travel route (public transportation route, driving route, bicycling route, walking route) based on search criteria (e.g., when, looking for, how far, etc.), route variables (e.g. distance to travel, area density, proximity to route) and destination profile (ratings, open/ close, costs).

The software allows users to:
Look for one or more places (e.g., restaurants, café) based on a list of categories
Specify what they are looking for (e.g., Dunkin Donuts)
Decide how soon/ far along the route to target the search (e.g., soon, later)
Access the software recommended destinations along the route and choose from the best options.
See how far off the walking, bicycling, driving, public transportation route each place is located
Filter and sort results based on priorities (e.g., recommended, distance, ratings)
Filter to expand your search area to view more options (e.g., 1, 5 miles off route)
Find places for more than one category at a time (i.e., multiple destinations) along the route
Store preferences and favorite places to visit them again
Excludes places you don't like from search results (e.g., certain cuisine)
Optimize search to exclude places the users don't like
Get the software “trip recommendations” anywhere in the world based on user preferences (e.g., Visit Cuban Restaurants and see Action Movie)
Calendar integration to track when you're going
Order from your favorite places on your route and pick up on the way (retail integrations—e.g. donuts).

The software helps users find the most convenient place to meet friends based on each friend's location and how each friend is traveling (e.g., public transportation, driving, walking, bicycling).

Using open API sources, the software makes recommendations for best places for friends to meet based on search criteria (e.g., when, looking for, etc.), location preferences (e.g., closer to specific friend, in the middle), destination profile (ratings, open/close, costs).

The algorithm applies certain criteria to determine search parameters based on the ‘closer to’ friend, proximity of all friends, travel mode of all friends, area density to recommend best options with most reasonable (min, max) travel time and route for all friends.

The software lets users:
Send friends invites to provide their location
Send reminders so no one's left out
Track the status (e.g., accepted, pending, expired, etc.) of invitations and user responses
Send/receive notifications of invitation, place confirmations and whose coming
Set location preferences to search (i.e., in the middle or closer to a specific friend)
Share the meeting place with everyone
Share whose coming, how they're traveling, how far and whose locations were considered in deciding the meeting place
See how long each friend is traveling and their route on the map
Optimize search results based on your friend's preferences (e.g., exclude a cuisine)
Book reservations (restaurants, etc.) through API in the software
Update the invite with new invitees
Pay for your friend's travel through API in the software
Expand your network, meet new friends)
Store favorite and who went places to visit them again
Optimize search to exclude places you don't like
Message friends through the app
Calendar integration for all friends
Auto reminders to remind friends to meet

The system may also utilize payment processing and prepayment features—either through API interface in the software with POS systems or payment servers. The system may have preordering functionality. This functionality would allow a user to preorder and/or prepay for food, goods, or services at a meeting location prior to the meeting taking place. For instance, if a meeting is occurring at a restaurant then a user may preorder food and/or prepay prior to leaving for the meeting. The preordering and prepayment may be for only the specific user or, alternatively, the user can preorder and prepay for goods and services for any number of other users who are also attending the meeting.

The system may be utilized in a number of ways. In the preferred method, the client computers utilize client-side applications. The client computer of the first user has a client-side application downloaded on it. The client-side application can have some or all of the instructions for operating the computerized method. The client-side application can track the location of the user, transmit information from one client computer to the server computer or another client computer.

The system may also track the position and travel of each user while they are in transit to the selected meeting location. The system can update the location of each user prior to the meeting time. If the system determines that one user is traveling at a slower rate of travel than originally calculated (due to traffic or unforeseen circumstances) then the system may recalculate a meeting location. The system determines the instant position of each user, the updated rate of travel for each user, and determines a new meeting location and time. The system then generates and sends a notification to each user of the updated meeting location and time. The client computers of each may generate maps showing the current locations each user attending the meeting.

The system may allow users to make reservations with restaurants through an API. The client-side application connects with the server computer, which in turn connects to a restaurant computer through API. The user can send a specific reservation request from the client-side application, through the server computer, to the restaurant computer. The restaurant computer completes the reservation and then sends the confirmation of the reservation back through the server computer to the client computer.

The system may allow users to send messages to each other. A first user enters a message in the client-side application of that user's client computer. The client computer sends the message to the server computer with instructions to send the message to the second user. The server computer may store a copy of the message in a database. When the second user signs in to the client-side application on the second user's client computer, the server computer transmits the message to the client computer of the second user. The second user can read the message through the client-side application on that user's client computer.

The system may also permit the user to pay for goods through the client-side application. The client-side application connects through the server computer by API to payment servers and payment systems of any business. The client-side application may also allow a user to place an order for goods from a business or restaurant, through the server computer connected to a business server computer.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A computerized method for determining a meeting location to be performed by a first client computer comprising one or more microprocessors and one or more nonvolatile memory units, a second client computer comprising one or more microprocessors and one or more nonvolatile memory units, and a server computer comprising one or more microprocessors and one or more nonvolatile memory units, wherein each of said nonvolatile memory units store instructions which, when executed by one or more microprocessors perform operations comprising
a) obtaining, by said server computer, a first physical location of said first client computer owned by a first user;
b) obtaining, by said server computer, a first selected mode of transportation of said first user
c) determining, by said server computer, a first rate of travel of said first selected mode of transportation;
d) determining, by said server computer, a first travel time for said first user;
e) calculating, by said server computer, a first range of travel for said first user from said first physical location of said first client computer;
f) obtaining, by said server computer, a second physical location of said second client computer owned by a second user;
g) obtaining, by said server computer, a second selected mode of transportation of said second user
h) determining, by said server computer, a second rate of travel of said second selected mode of transportation;
i) determining, by said server computer, a second travel time for said second user;
j) calculating, by said server computer, a second range of travel for said second user from said second physical location of said second client computer;
k) determining, by said server computer, a first geographic area
i) wherein said first geographic area is an overlap between said first range of travel for said first user from said first physical location of said first client computer and said second range of travel for said second user from said second physical location of said second client computer;
l) searching, by said server computer, a public database for one or more potential meeting locations, wherein said one or more potential meeting locations are within said first geographic area; and
m) determining, by said server computer, a final specific meeting location in said first geographic area.

2) The computerized method as in claim 1
a) wherein obtaining a first selected mode of transportation of said first user further comprises
i) sending, by said server computer, a request for a first mode of transportation to said first client computer;
ii) receiving, by said first client computer, said request for said first mode of transportation of said first user;
iii) receiving, by said first client computer, a first selected mode of transportation of said first user;
iv) sending, by said first client computer, to said server computer a first selected mode of transportation of said first user; and
v) receiving, by said server computer, said first selected mode of transportation;
b) wherein obtaining a second selected mode of transportation of said second user further comprises
i) sending, by said server computer, a request for a second mode of transportation to said second client computer;
ii) receiving, by said second client computer, said request for said second mode of transportation of said second user;
iii) receiving, by said second client computer, a second selected mode of transportation of said second user; and
iv) sending, by said second client computer, to said server computer said second selected mode of transportation of said second user.

3) The computerized method as in claim 2 wherein said first selected mode of transportation is selected from a group consisting of: walking, bicycling, driving a car, driving a motorized bicycle, riding in a bus, riding a train, riding in an airplane and wherein said second mode of transportation is selected from a group consisting of walking, bicycling, driving a car, driving a motorized bicycle, riding in a bus, riding a train, riding in an airplane.

4) The computerized method as in claim 1 further comprising
a) sending, by said server computer, to said first client computer, a first request for a first set of one or more preferences;
b) receiving, by said first client computer, said first request for said first set of one or more preferences;
c) receiving, by said first client computer, said first set of one or more preferences;
i) wherein said first set of one or more preferences is selected from a group consisting of: a specific date and time, a preferred mode of transportation, a type of cuisine, a preferred distance of travel, a distance beyond a route of travel;
d) transmitting, by said first client computer, said first set of one or more preferences to said server computer;
e) sending, by said server computer, to said second client computer, a second request for a second set of one or more preferences;
f) receiving, by said second client computer, said second request for said second set of one or more preferences;
g) receiving, by said second client computer, said second set of one or more preferences;
i) wherein said second set of one or more preferences is selected from a group consisting of: a specific date and time, a preferred mode of transportation, a type of cuisine, a preferred distance of travel, a distance beyond a route of travel; and
h) transmitting, by said second client computer, said second set of one or more preferences to said server computer.

5) The computerized method as in claim 1
a) wherein the step of calculating a first range of travel for said first user further comprises multiplying said first rate of travel of said first selected mode of transportation by said first travel time for said first user; and
b) wherein the step of calculating a second range of travel for said second user further comprises multiplying said second rate of travel of said second selected mode of transportation by said second travel time for said second user.

6) The computerized method as in claim 1 further comprising
a) transmitting, by said server computer, said final specific meeting location to said first client computer;
b) transmitting, by said server computer, said final specific meeting location to said second client computer;
c) transmitting, by said server computer, said final specific meeting time to said first client computer; and
d) transmitting, by said serer computer, said final specific meeting time to said second client computer.

7) The computerized method as in claim 1 further comprising
a) generating, by said server computer, a list of said one or more potential meeting locations; and
b) filtering said list of said one or more potential meeting locations.

8) The computerized method as in claim 1 further comprising
a) transmitting, by said first client computer, one or more first potential meeting times to said server computer;
b) transmitting, by said second client computer, one or more second potential meeting times to said server computer;
c) comparing, by said server computer, said one or more first potential meeting times to said one or more second potential meeting times;
d) determining, by said server computer, a final specific meeting time; and
e) transmitting, by said server computer, said final meeting time to said first client computer and said second client computer.

9) The computerized method as in claim 1 further comprising
a) searching, by said server computer, a public database for one or more specific location data points for each of said one or more potential meeting locations;
i) wherein said one or more specific location data points are selected from a group consisting of: time of operation of a business, type of cuisine of a restaurant, public rating, business name, location name, GPS, business location, scheduled events; and
b) determining, by said server computer, a final specific meeting location in said first geographic area based on one or more specific location data points.

10) The computerized method as in claim 9 further comprising
a) comparing, by said server computer, said one or more specific location data points to one or more preferences of said first user;
b) determining, by said server computer, one or more specific location data points that match one or more preferences of said first user;
c) comparing, by said server computer, said one or more specific location data points to one or more preferences of said second user; and
d) determining, by said server computer, one or more specific location data points that match one or more preferences of said second user.

11) The computerized method as in claim 4 further comprising
a) searching, by said server computer, a public database for one or more specific location data points for each of said one or more potential meeting locations;
i) wherein said one or more specific location data points are selected from a group consisting of: time of operation of a business, type of cuisine of a restaurant, public rating, business name, location name, GPS, business location, scheduled events; and
b) determining, by said server computer, a final specific meeting location in said first geographic area based on one or more specific location data points.

12) The computerized method as in claim 9 further comprising
a) comparing, by said server computer, said one or more specific location data points to said first set of one or more preferences;
b) determining, by said server computer, one or more specific location data points that match at least one of said first set of one or more preferences of said first user;
c) comparing, by said server computer, said one or more specific location data points to said second set of one or more preferences; and
d) determining, by said server computer, one or more specific location data points that match at least one of said second one or more preferences.

13) The computerized method as in claim 12
a) wherein the step of calculating a first range of travel for said first user further comprises multiplying said first rate of travel of said first selected mode of transportation by said first travel time for said first user; and
b) wherein the step of calculating a second range of travel for said second user further comprises multiplying said second rate of travel of said second selected mode of transportation by said second travel time for said second user.

14) The computerized method as in claim 13 further comprising
a) transmitting, by said server computer, said final specific meeting location to said first client computer;
b) transmitting, by said server computer, said final specific meeting location to said second client computer;
c) transmitting, by said server computer, said final specific meeting time to said first client computer; and
d) transmitting, by said serer computer, said final specific meeting time to said second client computer.

15) The computerized method as in claim 14 further comprising
a) generating, by said server computer, a list of said one or more potential meeting locations; and
b) filtering said list of said one or more potential meeting locations;
c) transmitting, by said first client computer, one or more first potential meeting times to said server computer;
d) transmitting, by said second client computer, one or more second potential meeting times to said server computer;
e) comparing, by said server computer, said one or more first potential meeting times to said one or more second potential meeting times;
f) determining, by said server computer, a final specific meeting time; and
g) transmitting, by said server computer, said final meeting time to said first client computer and said second client computer.

16) (canceled)

17) The computerized method as in claim 15
a) wherein obtaining a first selected mode of transportation of said first user further comprises
i) sending, by said server computer, a request for a first mode of transportation to said first client computer;
ii) receiving, by said first client computer, said request for said first mode of transportation of said first user;
iii) receiving, by said first client computer, a first selected mode of transportation of said first user;
iv) sending, by said first client computer, to said server computer a first selected mode of transportation of said first user; and
v) receiving, by said server computer, said first selected mode of transportation;
b) wherein obtaining a second selected mode of transportation of said second user further comprises
i) sending, by said server computer, a request for a second mode of transportation to said second client computer;
ii) receiving, by said second client computer, said request for said second mode of transportation of said second user;
iii) receiving, by said second client computer, a second selected mode of transportation of said second user; and
iv) sending, by said second client computer, to said server computer said second selected mode of transportation of said second user; and
v) wherein said first selected mode of transportation is selected from a group consisting of: walking, bicycling, driving a car, driving a motorized bicycle, riding in a bus, riding a train, riding in an airplane and wherein said second mode of transportation is selected from a group consisting of walking, bicycling, driving a car, driving a motorized bicycle, riding in a bus, riding a train, riding in an airplane.

18) A computerized method for determining a meeting location to be performed by a first client computer comprising one or more microprocessors and one or more nonvolatile memory units, and a server computer comprising one or more microprocessors and one or more nonvolatile memory units, wherein each of said nonvolatile memory units store instructions which, when executed by one or more microprocessors perform operations comprising
a) receiving, by said first client computer, a request for a first meeting location;
b) receiving, by said first client computer, a list of one or more potential attendees;
c) transmitting, by said first client computer, said request for a first meeting location and said list of one or more potential attendees to said server computer;
d) searching, by said server computer, a user database for one or more user profile records matching said one or more potential attendees;
e) finding, by said server computer, one or more database records of said one or more user profile records on said user database;
i) wherein said one or more database records comprise one or more first preferences for a first potential attendee and one or more second preferences for a second potential attendee;
(1) wherein said one or more first preferences are selected from a group consisting of: a specific date and time, a preferred mode of transportation, a type of cuisine, a preferred distance of travel, a distance beyond a route of travel, a user physical location;
(2) wherein said one or more second preferences are selected from a group consisting of: a specific date and time, a preferred mode of transportation, a type of cuisine, a preferred distance of travel, a distance beyond a route of travel, a user physical location;
f) obtaining, by said server computer, one or more first preferences and one or more second preferences from said user database;
g) searching, by said server computer, a location database for one or more potential meeting locations records
i) wherein said one more potential meeting location records further comprise one or more potential meeting location data points, wherein said one or more potential meeting location data points are selected from a group consisting of: time of operation of a business, type of cuisine of a restaurant, public rating, business name, location name, GPS, business location, scheduled events, physical location;
h) comparing, by said server computer, one or more potential meeting location data points to one or more first preferences and one or more second preferences;
i) determining, by said server computer, a match between said one or more potential meeting location data points and said one or more first preferences;
j) determining, by said server computer, a match between said one or more potential meeting location data points and said one or more second preferences;
k) selecting, by said server computer, one or more potential meeting location records wherein said one or more potential meeting location data points match said one or more first preferences and said one or more second preferences;
l) generating, by said server computer, a list of potential meeting locations; and
m) transmitting, by said server computer, said list of potential meeting locations to said first client computer.

19) The computerized method as in claim 18 further comprising
a) wherein said one or more database records further comprise a first order of priority for said one or more first preferences and a second order of priority for said one or more second preferences;
b) obtaining by said server computer, said first order of priority and said second order of priority;
c) respectively applying, by said server computer, one or more first priority values to said one or more first preferences;
d) respectively applying, by said server computer, one or more second priority values to said one or more second preferences;
e) determining, by said server computer, a first prioritized first preference and a first prioritized second preference;
f) selecting, by said server computer, a specific meeting location record based on said first prioritized preference and said first prioritized second preference.

20) The computerized method as in claim 19 further comprising
a) receiving, by said first client computer, one or more location parameters;
b) transmitting, by said first client computer, said one or more location parameters, to said server computer;
c) comparing, by said server computer, said one or more potential meeting location data points to said one or more location parameters;
d) determining, by said server computer, a match between said one or more potential meeting location data points and said one or more location parameters; and
e) selecting, by said server computer, one or more potential meeting location records wherein said one or more potential meeting location data points match said one or more location parameters.

21) A computerized method for determining a geographic location to be performed by a first client computer comprising one or more microprocessors and one or more nonvolatile memory units and a server computer comprising one or more microprocessors and on or more nonvolatile memory units, wherein each of said nonvolatile memory units store instructions which, when executed by one or more microprocessors perform operations comprising
a) obtaining, by said first client computer, a first physical location of said first client computer owned by a first user;
b) obtaining, by said first client computer, a first selected mode of transportation of said first user;
c) determining, by said first client computer, a first rate of travel of said first selected mode of transportation;
d) determining, by said first client computer, a first travel time for said first user;
e) calculating, by said first client computer, a first range of travel for said first user from said first physical location of said first client computer;
f) sending, by said server computer, to said first client computer, a first request for a first set of one or more preferences;
g) receiving, by said first client computer, said first request for said first set of one or more preferences;
h) receiving, by said first client computer, said first set of one or more preferences;
i) wherein said first set of one or more preferences is selected from a group consisting of: a specific date and time, a preferred mode of transportation, a type of cuisine, a preferred distance of travel, a distance beyond a route of travel;
i) transmitting, by said first client computer, said first set of one or more preferences to said server computer;
j) searching, by said server computer, a public database for one or more specific location data points for each of one or more potential locations;
i) wherein said one or more specific location data points are selected from a group consisting of: time of operation of a business, type of cuisine of a restaurant, public rating, business name, location name, GPS, business location, scheduled events;
k) comparing, by said server computer, said one or more specific location data points to one or more preferences of said first user;
l) determining, by said server computer, one or more specific location data points that match one or more preferences of said first user;
m) determining, by said server computer, a final specific location in said first range of travel based on one or more specific location data points; and
n) transmitting, by said server computer, said final specific location to said first client computer.
